(19) United States
(12) Patent Application Publication
(10) Pub. No.: US 2013/0050611 A1
(43) Pub. Date: Feb. 28, 2013

(54) HIGH BRIGHTNESS AND CONTRAST MULTIPLE-VIEW DISPLAY

(71) Applicant: Lesley Anne PARRY-JONES, Courtenay (GB)

(72) Inventor: Lesley Anne PARRY-JONES, Courtenay (GB)

(73) Assignee: SHARP KABUSHIKI KAISHA, Osaka (JP)

(21) Appl. No.: 13/215,479

(22) Filed: Aug. 23, 2011

(51) Int. Cl. G02F 1/1335

(52) U.S. Cl. 349/62

(57) ABSTRACT

A multiple-view display which includes a liquid crystal display base panel including an entrance substrate and an exit substrate which sandwich a nematic liquid crystal layer; a backlight on a side of the liquid crystal base panel opposite a side of a viewer; an entrance polarizer positioned between the backlight and the entrance substrate; an exit polarizer positioned between the exit substrate and the viewer; and a parallax element positioned between the exit substrate and the exit polarizer, the parallax element being aligned relative to pixels within the liquid crystal base panel to create different viewing regions, wherein in a display mode nematic liquid crystal within the liquid crystal layer is in a vertically aligned nematic (VAN) liquid crystal mode.

### TECHNICAL FIELD

This invention relates to a design for high brightness, high contrast dual view LCDs. The design uses a microlens array to achieve high brightness, and a vertically aligned nematic liquid crystal mode to achieve high contrast ratio.

### BACKGROUND ART

Dual view displays are useful for a number of applications in which it is desirable to display two different images to two different angles of observation. A good example is in the center console of an automobile. Whilst it is useful for the driver on one side to be able to see GPS information for navigational purposes, this information may be of no interest to the passenger who might prefer to watch a DVD or browse the internet. To have two separate displays to suit both purposes costs valuable space in a confined area, and in addition there may be legal issues associated with the driver being able to see images from a DVD (for example) which could be distracting and potentially dangerous. By using a dual view display, space is saved, and, provided that the cross-talk between the images is low, driver distraction by the passenger's image can be kept to a safe level.

Dual view functionality is usually provided with some kind of additional optical element which can either block or steer the light emerging from the display pixels, so that only the relevant pixels can be viewed from certain directions. An example is illustrated in FIG. 1, which shows a dual view liquid crystal display design based on a parallax barrier. A parallax barrier (1), consisting of a series of absorbing stripes alternating with a series of transmitting stripes, is placed either between the display backlight (2) and the liquid crystal layer (3), or between the liquid crystal layer (3) and the viewer (4). The latter of these two cases is shown in FIG. 1. In this case, the exit polarizer (5b) of the display can either be placed between the parallax barrier (1) and the liquid crystal layer (3), or between the parallax barrier (1) and the observer (4), as shown in FIGS. 1(a) and 1(b) respectively. The pitch of the parallax barrier (1) shown in FIG. 1 is twice that of the pixels (e.g., 6a, 6b) of the display. With this arrangement, and with the transmitting stripes aligned between every other pixel, it is clear that one half of the pixels (6a) can be viewed by the viewer on the left (4a), and the other half of the pixels (6b) can be viewed by the viewer on the right (6b). The angle at which each set of pixels can best be viewed is determined by the pitch of the parallax barrier (1) (and hence the pixel pitch), the separation between the parallax barrier (1) and the liquid crystal layer (3), and the refractive index of the medium of separation (7) between the liquid crystal layer (3) and the parallax barrier (1). The liquid crystal layer (3) is sandwiched between entrance (8a) and exit (8b) substrates, and the entrance polarizer (5a) is positioned between the backlight (2) and entrance substrate (8a). The parallax barrier (1) is adhered to the exit polarizer (5b) in the case of FIG. 1(a), and the exit substrate (8b) in the case of FIG. 1(b), by a layer of glue 9.

For automotive applications the typical desired viewing angles from the normal to the display are ±40°, and a typical pixel pitch is around 75 microns. A simple geometric calculation, assuming that the medium of separation (7) has a refractive index similar to that of glass (n˜1.52), leads to the conclusion that the separation between the parallax barrier (1) and the liquid crystal layer (3) must be of the order of 80 microns. Given that standard LCD substrates are generally at least a few hundreds of microns thick, and likewise standard iodine polarizers, this leads to some design and manufacturing challenges.

One solution is to place the parallax barrier (1) between the exit polarizer (5b) and the liquid crystal layer (3) (as shown in FIG. 1(b)) and to thin the exit substrate (8b) to around 50 microns. Once the parallax barrier (1) is adhered to the exit substrate (8b) with a thin (˜30 micron) layer of glue (9), the separation between the liquid crystal layer (3) and the parallax barrier is of the order of 80 microns, as required. Thus the design and manufacture of a dual view display for automotive applications is possible, as disclosed in U.S. Pat. No. 7,518,664 (Mather et al., issued Apr. 14, 2009).

One disadvantage of dual view displays made using a parallax barrier is that because each viewer only observes one half of the pixels, with the other half blocked from view, the resolution is halved and the brightness is significantly lower than that which would be viewed in an equivalent single view display with no parallax barrier. A partial solution to the brightness drop is to use a microlens array instead of a parallax barrier. However, this can lead to quite a high level of cross-talk between the two images, which is disadvantageous from a safety point of view (because the driver could become distracted by the cross-talk from the passenger-view image). A good compromise, disclosed in US2007/058258 (Mather et al., pub. Mar. 15, 2007) is to use a microlens array in combination with a parallax barrier to form a microlens array and parallax barrier element (14), as illustrated in FIG. 2 for the case where the exit polarizer (5b) is placed between the combined microlens array and parallax barrier element (14) and the observer (4). The microlenses used are somewhat smaller than would be used in a pure microlens solution with no parallax barrier, and the transmissive parts of the parallax barrier are wider than would be possible if no microlenses were present. The display is therefore brighter than a parallax barrier only system, but still with an acceptable level of cross-talk between the two images.

As described above for the automotive dual view display geometry, in order to create the viewing windows at the correct angles from the display normal, it is necessary to place the parallax elements between the liquid crystal layer (3) and the exit polarizer (5b). Replacing a parallax barrier with a microlens array combined with parallax barrier may slightly change the required separation between the liquid crystal layer (3) and the parallax element, but it will probably still be necessary for it to be between the liquid crystal layer (3) and the exit polarizer (5b). This can be problematic because the microlenses can change the polarisation state of the light as it passes between the two polarizers, and therefore reduce the contrast ratio of the display. This drop in contrast ratio can occur via a number of different mechanisms, which are illustrated in FIG. 3.

FIG. 3(a) shows in detail the refraction of a ray of light as it travels through a single microlens made of a medium of higher refractive index than that of its surroundings. In general, the transmission coefficient for light polarised parallel (p) and perpendicular (s) to an interface between two media of differing refractive index is different, and hence the polarisation of light will change both on entering and exiting the microlens. Therefore, in general, both the angle of propagation and the polarisation of light emerging from the microlens will be different to that entering the microlens, hence the polarisation of light striking the exit compensation film or exit polarizer will not be the same as if the microlens was not there. The compensation will in general not function exactly as it was designed to do if the microlens array was absent, and as a result the contrast ratio will generally drop.

A further mechanism by which the contrast ratio of an LCD is affected by a microlens array is illustrated in FIG. 3(b). The same mechanism that causes the change in polarisation of a ray transmitted through any interface between two media of differing refractive index also gives rise to reflected rays which lead to multiple reflections within the device. FIG. 3(b) shows an example of a multiply-reflected ray path that can occur within the layer of material surrounding the microlenses of a microlens array, which must necessarily be of a different refractive index to the microlenses (in order for them to have a beam-steering effect). In general, there will be a polarisation change at every reflection, and hence multiply-reflected rays that eventually emerge from the display will in general be of a different polarisation to the ray which is transmitted straight through without any reflections, leading to a drop in contrast ratio.

FIG. 3(c) shows another mechanism by which the contrast ratio is affected by a microlens array (13). There, it is illustrated how the light that reaches the observer (4) is a combination of a number of rays that have traveled through the entrance polarizer (2a), entrance compensation film (10a) and liquid crystal layer (3) at a variety of different angles of incidence, and the microlens array (13) has diverted them to the angle of viewing determined by the observer. Of course the rays have different weighting in terms of power, according to the properties of the microlens array (13). However, it is clear that the light reaching the exit compensation film (10b) can consist of a mixture of different polarisations, and in that case the exit compensation film (10b) of course cannot compensate correctly for all of those polarisations. As a result, the contrast of the display will in general drop.

Although illustrated and explained for the case of a microlens array, all of the arguments above are applicable to a combined microlens array and parallax barrier, and even for a pure parallax barrier the second mechanism can apply. It is therefore apparent that any parallax element added between the polarizers of a liquid crystal display, whether to create a dual view function, or for any other reason, can have a detrimental effect on the contrast ratio of the display.

The use of microlenses or other optical elements in conjunction with LCDs is not uncommon. For example, EP 0791 847 A1 (Van Berkel et al., pub. Aug. 27, 1997) and WO 03/015424 A2 (Woodgate et al., pub. Feb. 20, 2003) describe the use of microlenses in order to create a 3D display. However, the microlens array is positioned outside the polarizers of the LCD, i.e. the image is already formed before the light enters the microlens array. Therefore, there is not the problem with loss of contrast associated with having the microlens array between the polarizers of the LCD as described above. This is very often the case with displays which are designed for 3D, because for the typical range of pixel sizes, and for the typical range of viewing distances, the separation required between the pixels of the LCD and the microlens array is usually large enough to allow for an external polarizer in between the pixels and the microlens array. This is not always the case for displays designed for other applications, such as Dual View or privacy, because for these applications it is generally necessary to steer the light emitted from the pixels through a much larger angle. This in turn generally requires a smaller separation between the pixels and the microlens array, and hence it is often not possible to place an external polarizer in this space, necessitating the microlens array to be positioned between the polarizers of the LCD.

There are some examples of 3D displays in which the microlens array is positioned between the polarizers, for example, as also disclosed in WO 03/015424 A2. However, this patent publication does not mention a loss in contrast ratio which occurs as a result of placing the microlens array between the entrance and exit polarizers of the display, nor does it mention any particular measures in which to minimize or eliminate any such loss in contrast ratio.

Patent publication US 2010/0039583 A1 (Usukura, pub. Feb. 18, 2010) describes the use of microlenses between the polarizers of an LCD in order to increase light throughput through the pixel apertures of the display. The publication discloses a number of measures which can be taken in order to maintain high contrast ratio in the display. However, the publication is restricted to the case in which the microlenses are placed between the entrance compensation film and the liquid crystal layer, and does not consider the case where the microlenses are between the liquid crystal layer and the exit compensation film. Neither does it consider the case of different optical elements, such as prisms, reflectors, diffractive elements or absorbers.

### SUMMARY OF INVENTION

This invention refers to a particular design of a multiple-view display, such as a dual view display, which uses a combined microlens and parallax barrier optical element to create the dual view function. The liquid crystal display mode chosen, the compensation films and orientation of the polarizers are chosen in such a way as to achieve both good brightness and contrast ratio. Specifically, the liquid crystal display mode is a single domain vertically aligned nematic mode, and the absorption axes of the polarizers are oriented parallel and perpendicular to the principle viewing plane, and the axis of the parallax element.

According to an aspect of the invention, a multiple-view display is provided which includes a liquid crystal display base panel including an entrance substrate and an exit substrate which sandwich a nematic liquid crystal layer; a backlight on a side of the liquid crystal base panel opposite a side of a viewer; an entrance polarizer positioned between the backlight and the entrance substrate; an exit polarizer positioned between the exit substrate and the viewer; and a parallax element positioned between the exit substrate and the exit polarizer, the parallax element being aligned relative to pixels within the liquid crystal base panel to create different viewing regions, wherein in a display mode nematic liquid crystal within the liquid crystal layer is in a vertically aligned nematic (VAN) liquid crystal mode.

According to another aspect, the VAN liquid crystal mode is a single domain VAN liquid crystal mode.

In accordance with another aspect, an absorption axis of the entrance polarizer and an absorption axis of the exit polarizer are perpendicular to each other, and one of the absorption axis of the entrance polarizer and the absorption axis of the exit polarizer is substantially parallel to an axis of the parallax element while the other of the absorption axis of the entrance polarizer and the absorption axis of the exit polarizer is substantially perpendicular to the axis of the parallax element.

In yet another aspect, the liquid crystal display base panel includes an alignment layer on each side of the liquid crystal layer which promotes the vertical alignment of the nematic liquid crystal.

According to another aspect, the alignment layer on each side of the liquid crystal layer has a rubbing direction substantially equal to 45° to the absorption axes of the entrance polarizer and the exit polarizer.

In still another aspect, at least one of the alignment layers is patterned so as to have a first rubbing direction in the pixels which contribute to a first of the viewing regions and a second rubbing direction in the pixels which contribute to a second of the viewing regions.

In accordance with another aspect, the first and second rubbing directions create +45° and −45° azimuthal alignment directions, respectively, relative to the absorption axes of the entrance polarizer and the exit polarizer.

According to still another aspect, the pixels comprise sub-pixels, and the alignment layer within the different sub-pixels creates different azimuthal orientations.

According to another aspect, the parallax element comprises a parallax barrier, a microlens array or a combined parallax barrier and microlens array.

In yet another aspect, the parallax element is a microlens array.

In accordance with another aspect, the nematic liquid crystal has negative dielectric anisotropy.

In still another aspect, the display further includes an entrance compensation film between the entrance polarizer and the entrance substrate and/or an exit compensation film between the parallax element and the exit polarizer.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1: Illustration of how a dual view display is created using a simple parallax barrier
a) exit polarizer placed between parallax barrier and liquid crystal layer
b) exit polarizer placed between parallax barrier and observer

FIG. 2: Illustration of how a dual view display is created using a combined microlens array and parallax barrier

FIG. 3: Illustration of the ways in which microlens array between the entrance and exit polarizers can affect the contrast ratio of a display:
a) polarization change at refractive interfaces
b) multiple reflections
c) multiple angles of travel through the liquid crystal layer contributing to one viewing angle

FIG. 4: Illustration of dual view display using single domain vertically aligned nematic liquid crystal mode as display mode in accordance with the present invention

FIG. 5: illustration of an embodiment of the invention:

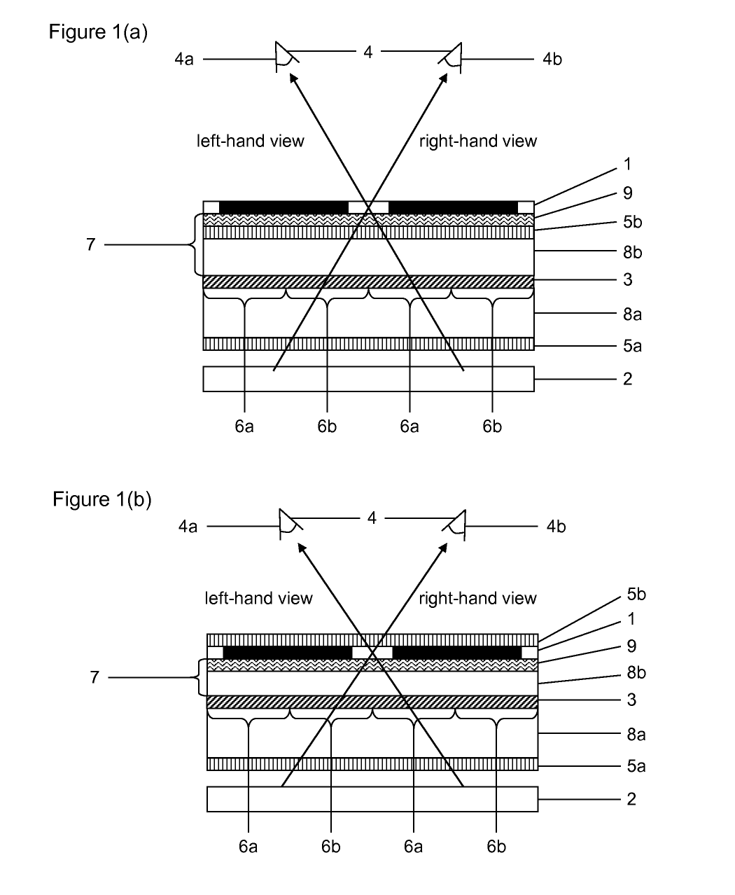

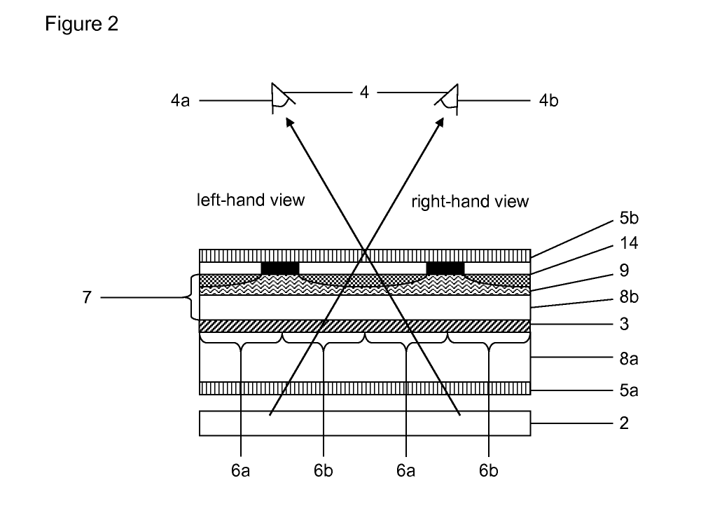

basic Dual View
(a) viewing windows
(b) liquid crystal panel
(c) azimuthal angles
(d) liquid crystal with voltage on

### DESCRIPTION OF REFERENCE NUMERALS

1 Parallax barrier
2 Backlight
3 Liquid crystal layer
4 Viewer
4a An observer at oblique incidence to the display (left hand side)
4b An observer at oblique incidence to the display (right hand side)
5 Polarizer
5a Entrance polarizer
5b Exit polarizer
6 Pixel
6a Pixel associated with image viewed from the left-hand side
6b Pixel associated with image viewed from the right-hand side
7 Medium of separation between liquid crystal layer and parallax barrier
8 Display substrate
8a Entrance substrate
8b Exit substrate
9 Glue layer
10 Compensation film
10a Entrance compensation film
10b Exit compensation film
11 LCD base panel
12 Parallax element
13 Microlens array
14 Microlens array combined with parallax barrier
15 Viewing region
15a Left-hand viewing region
15b Right-hand viewing region
16 Alignment layer
17 Transparent pixel electrode
17a Electrode for addressing pixel which is part image viewed from the left-hand side
17b Electrode for addressing pixel which is part of image viewed from the right-hand side
17c Counter electrode, common to all pixel electrodes
18 Thin-film transistor (TFT)
19 Colour filter

### DETAILED DESCRIPTION OF INVENTION

This invention involves the use of a single domain vertically aligned nematic liquid crystal mode as the liquid crystal display mode in a dual view display.

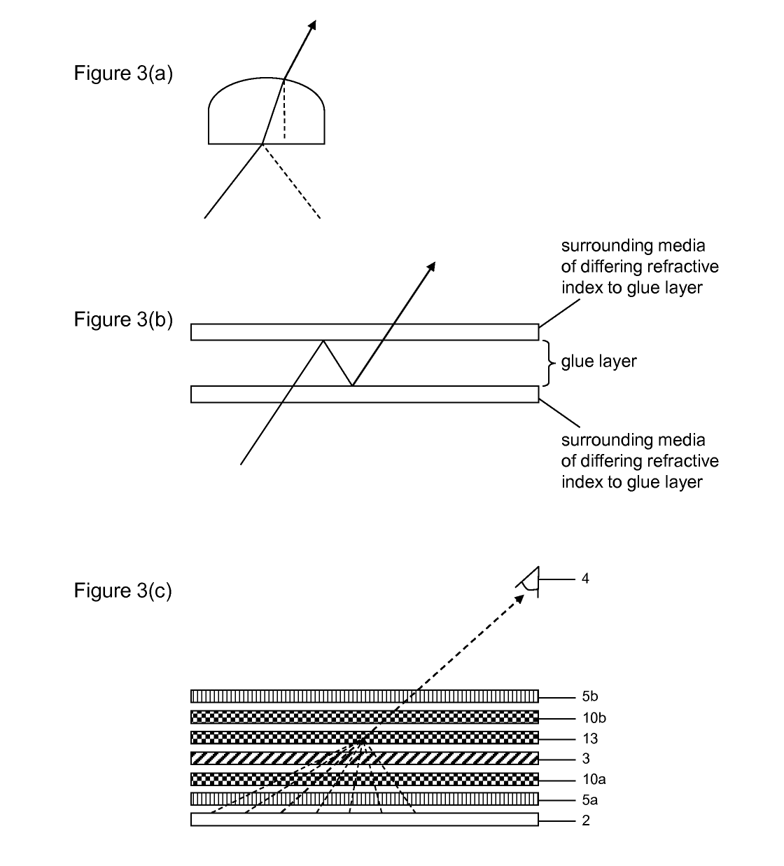

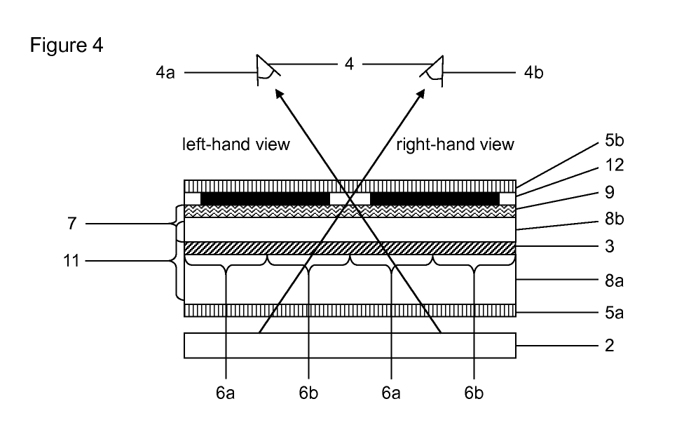

FIG. 4 illustrates a multiple-view display, and more particularly a dual view display, according to one aspect of the invention. A liquid crystal display base panel (11) is composed of two glass substrates (8a and 8b) which sandwich a liquid crystal layer (3). A backlight (2) is placed on the opposite side of the liquid crystal display base panel (11) to the viewer (4). An entrance polarizer (5a) is positioned between the backlight (2) and the entrance substrate (8a). An exit polarizer (5b) is positioned between the exit substrate (8b) and the viewer (4). A parallax element (12) is placed between the exit substrate (8b) and the exit polarizer (5b), and may be secured to the exit substrate (8b) with a thin layer of glue (9). The parallax element (12) could be a parallax barrier (1), a microlens array (13) or a combined parallax barrier and microlens array (14), for example. In another embodiment, the parallax element (12) may include any parallax element with a means of changing the direction of light that passes through it, e.g., prisms, diffraction gratings, grin lenses, etc.

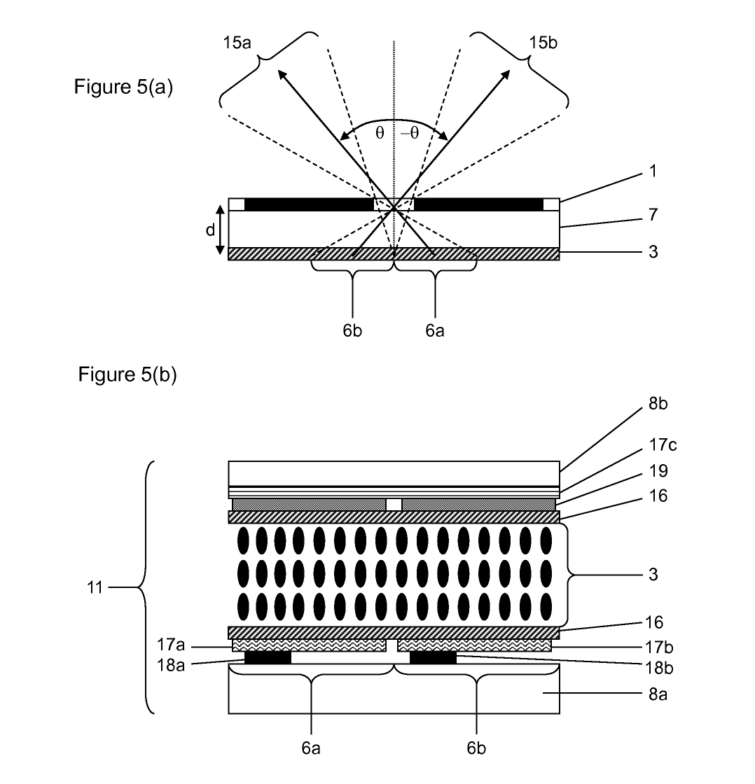

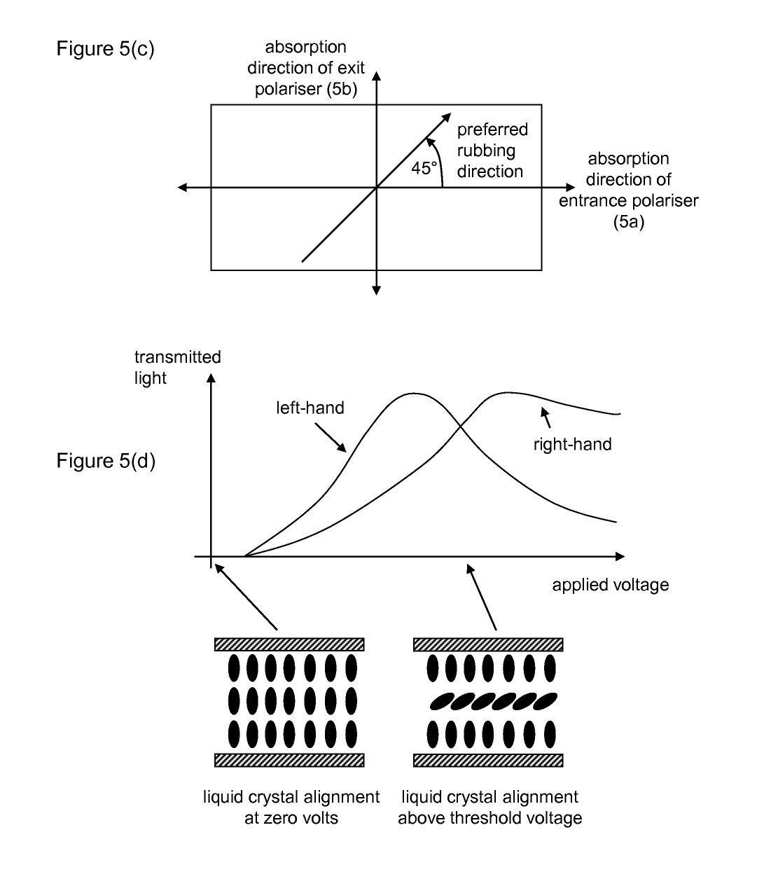

FIG. 5(a) illustrates the positioning and alignment of a parallax barrier (1), representing the parallax element, with respect to the pixels (6a and 6b) of the display. The pitch of the parallax barrier (1) is substantially equal to twice the pitch of the pixels. A small departure from exactly a factor of 2 between the two pitches maybe intentionally be used in order to correct for a slightly different viewing angle by a nearby viewer (4) as a function of position across the display. In order to create first and second viewing regions (15a and 15b) which are symmetrically disposed about the normal to the display, the center of the transparent regions of the parallax barrier (1) should be aligned with the half-way points between two adjacent pixels (6a and 6b). The viewing region (15a) from the pixel set (6a) corresponding to the left-hand image is centered on a viewing angle of θ to the normal of the display. The viewing region (15b) from the pixel set (6b) corresponding to the right-hand image is centered on a viewing angle of −θ to the normal of the display. The magnitude of the viewing angle (in air) θ is given by the following equation:

$$θ = {sin}^{- 1} ( n sin ( {tan}^{- 1} ( \frac{p}{2 d} ) ) ) ,$$

where p is the pixel pitch, d is the vertical separation between the plane of the pixels (co-incident with the liquid crystal layer (3)) and the plane of the parallax barrier (1), and n is the refractive index of the medium (7) that separates the pixels from the parallax barrier. Usually, this medium will consist of the exit substrate (8b) of the liquid crystal display base panel (11), and the layer of glue (9) that attaches the parallax barrier (1) to the exit substrate (8b), as illustrated in FIG. 4.

FIG. 5(b) illustrates in greater detail the liquid crystal display base panel (11). The liquid crystal layer (3) is adjacent on both sides to alignment layers (16). According to the present invention, the alignment layers (16) are of a known type selected to promote homeotropic or vertical alignment, such that the preferred orientation of the liquid crystal director adjacent to the alignment layers (16) (in the absence of any other external influence such as electric field) is perpendicular to the alignment layer surface, as illustrated in FIG. 5(b). Such liquid crystal alignment under zero applied electric field is generally known as “vertical alignment”. Since the liquid crystal used is in the nematic phase, another well-known term is “VAN” or “Vertically-Aligned-Nematic”. Either side of the alignment layers (16) are transparent electrodes (17) which are often made of a transparent conductive oxide such as indium-tin-oxide (ITO). On the entrance side of the liquid crystal layer (3), the transparent electrodes (17) are patterned into individual pixel electrodes (17a and 17b), and each pixel electrode is connected to its own unique thin-film-transistor (TFT) (18a and 18b, respectively), in order that each pixel can be addressed with a different applied voltage or electric field. On the exit side of the liquid crystal layer (3), the transparent electrode (17) may also be patterned, or could instead be a uniform and un-patterned layer. FIG. 5(b) shows two pixels (6a) and (6b), the first of which is part of the set of pixels which contributes to the left-hand image of the dual view display (when combined with the parallax elements as previously described), and the second of which is part of the set of pixels which contributes to the right-hand image of the dual view display (when combined with the parallax elements as previously described). The arrangement shown has correspondingly two pixel electrodes (17a and 17b) and two TFTs (18a and 18b) on the entrance substrate (8a) and one counter-electrode (17c) on the exit substrate (8b). Optionally, for a colour display, the exit substrate (8b) can also include colour filters (19) which are usually positioned between the counter-electrode (17c) and the alignment layer (16).

When the pixels are addressed, i.e. a voltage is applied between the counter-electrode (17c) and the pixel electrodes (17a and 17b), the liquid crystal director within the liquid crystal layer (3) changes its orientation according to a balance of electrical and elastic (restoring) forces. In this invention, the nematic liquid crystal used has a negative dielectric anisotropy, so that the action of the applied voltage is to rotate the director in the center of the liquid crystal layer (3) away from being perpendicular to the pixel electrodes (17). If the initial orientation of the liquid crystal director is exactly vertical, then there is degeneracy in the direction of this rotation in the azimuthal direction with respect to the normal of the initial alignment direction. In practice, this degeneracy is normally purposefully broken during the manufacture of the display by rubbing the alignment layers (16) in a particular direction. This has the effect that when the pixels are addressed, the director in the centre of the liquid crystal layer (3) has a preferred azimuthal direction in which to rotate, and the reorientation can occur quickly and predictably in that direction. In order for the change in the director under applied field to create an electro-optical effect (when combined with entrance and exit polarizers), it is necessary for the rubbing direction to be at an angle to the absorption axes of the polarizers. In this invention, the absorption axes of the entrance and exit polarizers are perpendicular to each other, and resultantly substantially parallel and substantially perpendicular to the axis of the parallax element (12). The axis of the parallax element (12) in turn is aligned with the horizontal or vertical axis of the pixels of the display. As will be appreciated by those having ordinary skill, the axis of the parallax element (12) in the case of a parallax barrier is represented by the parallax barrier slits. In the case of a microlens array (13), for example, the axis is a line parallel to the length of the cylindrical lenses. The greatest optical modulation occurs when the rubbing direction is half-way in between the two absorption axes, i.e. substantially equal to 45° to the two absorption axes, as illustrated in FIG. 5(c). An illustration of the resulting liquid crystal alignment when pixel electrodes (17a and 17b) are addressed with a suitable voltage above the switching threshold of the liquid crystal is given in FIG. 5(d). It must be noted that because the rubbing direction of the alignment layers is not co-planar with the plane of the diagram (but at 45° into the page), then this is also true of the liquid crystal director in the center of the liquid crystal layer (3). Also included in FIG. 5(d) is an indication of the electro-optic response that could be expected to be measured in the left and right-hand views, as a function of the applied voltage via the pixel electrodes (17a and 17b). Note that the two electro-optic responses are not the same for the left and right-hand views: this is a direct result of the asymmetry of the liquid crystal director orientation in the addressed state. It is therefore clear that in order to reach a particular grey-level in the left-hand image, a different voltage must be applied to the left-hand view pixel electrodes (17a) than the voltage which must be applied to the right-hand view pixel electrodes (17b) in order to reach the same grey-level in the right-hand image. This means that there must be a different “look-up table” for the two sets of pixels which correspond to the two different views.

In order to avoid having two look-up tables, it is necessary to have an electro-optic response which is identical between left and right-hand views. One way to do this is to subdivide the pixel into sub-pixels (or domains) in which the liquid crystal alignment has a different azimuthal orientation in the different domains. This differing alignment can be achieved in a variety of different ways, which include the use of patterned alignment. This is a commonly used technique to improve the viewing angle characteristics in standard liquid crystal displays which need to be viewable from a wide range of different angles, for example, those used in mobile phones and televisions. However, although this approach is used almost ubiquitously in VAN mode liquid crystal displays, it has the disadvantage of loss of brightness at the boundaries between the domains, and hence is an unfavorable approach for dual view displays, where brightness loss must be kept to a minimum. In another embodiment of this invention, an alternative which is generally only suitable for Dual View displays is to use a patterned alignment approach with first and second rubbing directions, not on a sub-pixel basis, as explained above, but in such a way as to create a completely different azimuthal alignment direction (say +45°) in the left-hand view pixels (6a) to that (say −45°) in the right-hand view pixels (6b). Such patterned alignment can be created using a multi-rubbing approach, or by using patterned photo-alignment.

As with any VAN mode liquid crystal display, the contrast ratio, particularly at oblique angles of incidence, can be improved via the use of compensation films, which are placed between the polarizers (5) and the liquid crystal layer (3). In most cases, the compensation films are adhered to the polarizer sheet, i.e. in FIG. 4 the entrance compensation film would be between the entrance polarizer (5a) and the entrance substrate (8a), and the exit compensation film would be between the parallax element (12) and the exit polarizer (5b). Typical compensation films for VAN mode liquid crystal displays usually include a negative c-plate retarder in order to compensate for the off-axis retardance of the vertically aligned liquid crystal in the zero volts state, and a positive a-plate retarder in order to compensate for the fact that at oblique angles of viewing the relative angle between the absorption axes of the polarizers is not 90° as it is when the display is viewed at normal incidence. Sometimes, the combined function of a negative c-plate and a positive a-plate are combined into a single biaxial film. Usually, the amount of retardance in the entrance and exit compensation films is equal. However, it is possible to have more retardance in one film than the other, or even to have all of the retardance in either the entrance or the exit compensation film, and none in the other, which is generally known as “single-sided compensation”. All of these various options for compensation are applicable to all embodiments of this invention.

The embodiments of this invention that have been described above were for the case where the parallax element (12) is a simple parallax barrier (1). However, all other aspects of the invention apply equally if the parallax element is either a microlens array (13) or a combined microlens array and parallax barrier (14), except that the calculation of the mid-angle of the viewing windows will be slightly different.

Furthermore, embodiments of the invention have been described primarily in the case where the different viewing regions are symmetric about a normal to the display. However, it will be appreciated that the viewing regions instead could be asymmetric without departing from the scope of the invention. Also, the invention is not limited to displays with only two different viewing regions, and may have more than two different viewing regions as will be appreciated.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention has been described with reference to a dual view display used for automotive applications. However it is equally applicable to a dual view display used for other applications such as portable devices, television, advertising, games consoles and digital signage. It is also applicable to any display which has viewing windows which are separated in angle, in which this is achieved by having two or more sets of sub-pixels which are each visible from different viewing regions. Besides dual-view displays, this can include triple-view displays or other multiple-view displays, privacy displays and 3D displays (collectively referred to herein as “multiple-view displays”). Even in the case that the parallax element is not inside the polarizers (typically the case in a 3D display), and hence not creating a potential reduction in the contrast ratio, the invention still has value in that the use of a single VAN domain per pixel (rather than a pixel which is individually multi-domained) will improve the brightness of the display.

1. A multiple-view display, comprising:
a liquid crystal display base panel including an entrance substrate and an exit substrate which sandwich a nematic liquid crystal layer;
a backlight on a side of the liquid crystal base panel opposite a side of a viewer;
an entrance polarizer positioned between the backlight and the entrance substrate;
an exit polarizer positioned between the exit substrate and the viewer; and
a parallax element positioned between the exit substrate and the exit polarizer, the parallax element being aligned relative to pixels within the liquid crystal base panel to create different viewing regions,
wherein in a display mode nematic liquid crystal within the liquid crystal layer is in a vertically aligned nematic (VAN) liquid crystal mode.

2. The multiple-view display according to claim 1, wherein the VAN liquid crystal mode is a single domain VAN liquid crystal mode.

3. The multiple-view display according to claim 1, wherein an absorption axis of the entrance polarizer and an absorption axis of the exit polarizer are perpendicular to each other, and one of the absorption axis of the entrance polarizer and the absorption axis of the exit polarizer is substantially parallel to an axis of the parallax element while the other of the absorption axis of the entrance polarizer and the absorption axis of the exit polarizer is substantially perpendicular to the axis of the parallax element.

4. The multiple-view display according to claim 1, wherein the liquid crystal display base panel includes an alignment layer on each side of the liquid crystal layer which promotes the vertical alignment of the nematic liquid crystal.

5. The multiple-view display according to claim 4, wherein the alignment layer on each side of the liquid crystal layer has a rubbing direction substantially equal to 45° to the absorption axes of the entrance polarizer and the exit polarizer.

6. The multiple-view display according to claim 4, wherein at least one of the alignment layers is patterned so as to have a first rubbing direction in the pixels which contribute to a first of the viewing regions and a second rubbing direction in the pixels which contribute to a second of the viewing regions.

7. The multiple-view display according to claim 6, wherein the first and second rubbing directions create +45° and −45° azimuthal alignment directions, respectively, relative to the absorption axes of the entrance polarizer and the exit polarizer.

8. The multiple-view display according to claim 4, wherein the pixels comprise sub-pixels, and the alignment layer within the different sub-pixels creates different azimuthal orientations.

9. The multiple-view display according to claim 1, wherein the parallax element comprises a parallax barrier, a microlens array or a combined parallax barrier and microlens array.

10. The multiple-view display according to claim 9, wherein the parallax element is a microlens array.

11. The multiple-view display according to claim 1, wherein the nematic liquid crystal has negative dielectric anisotropy.

12. The multiple-view display according to claim 1, further comprising an entrance compensation film between the entrance polarizer and the entrance substrate and/or an exit compensation film between the parallax element and the exit polarizer.
